(19) United States
(12) Patent Application Publication
(10) Pub. No.: US 2004/0253969 A1
(43) Pub. Date: Dec. 16, 2004

(54) Technique for discovery using a wireless network

(75) Inventors: Vu X. Nguyen, Seattle, WA (US); Chris Turkstra, Woodinville, WA (US); John Schussler, Redmond, WA (US); Neal Tucker, Seattle, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/456,917

(22) Filed: Jun. 6, 2003

(51) Int. Cl. G06F 15/177; H04B 7/00; H04Q 7/20

(52) U.S. Cl. 455/515; 455/67.11

(57) ABSTRACT

A method for connecting a client device to a host device over a wireless connection is directed to a client device such as a Smart Display. The client device receives an identifier and parses the identifier to retrieve embedded configuration information. The identifier follows a protocol limiting the identifier to providing only a network name, such as IEEE 802.11x. The embedded configuration information assists in establishing communications between the client device and the host device because the embedded configuration information can be used to identify the host. If the identifier is a service set identifier (SSID) described by an IEEE 802.1x protocol, the embedded configuration information can identify a TCP/IP address. The method includes comparing bytes of the received identifier with a stored identifier to determine a match. If a match is found, received identifier can be parsed for data for determining model type, a manufacturer identifier and a device type.

### FIELD OF THE INVENTION

This invention relates generally to computer and, more particularly, relates to capability discovery and display configuration in wireless networks.

### BACKGROUND OF THE INVENTION

Wireless networks are becoming increasingly common. The Institute of Electrical and Electronic Engineers (IEEE) has defined four standards for wireless networks known as 802.11, 802.11a, 802.11b, and 802.11g. These four standards will be collectively referred to as 802.11x. All four standards make use of the same medium access control (MAC) layer.

The 802.11x standards do not specify a mechanism to discover the capabilities of or configure devices on the network. Discovery is the process by which one device can learn the capabilities of a second device. For example, when a personal computer running Microsoft Windows XP operating system discovers a new device on a universal serial bus (USB), there is a protocol which operates over the USB and allows the device to identify itself and the device capabilities to the Windows operating system. This information allows Microsoft Windows to take actions such as installing drivers for the device without the need for user intervention and has greatly improved the process of hardware installation in personal computers. Device configuration consists of setting device parameters to set devices into the desired mode of operation. For example, a new device on the PCI bus must have I/O and DMA addresses, interrupt usage, and usually many device specific parameters are configured in order to function properly and not conflict with other devices on the bus.

The lack of configuration and discovery protocols is not a serious limitation for networked computers which simply require access to data or the internet. However, for several other types of devices the lack of a mechanism to discover device capabilities is a serious impairment. For example, Smart Displays are currently being developed which allow wireless connection of the computer display device to a host computer. If the Smart Display is using an 802.11x network to attach to a host, there is no way for the Smart Display to indicate to the host what type of device is connecting and what it's capabilities are or even to get very rudimentary information such as the IP number of the host which is necessary to establish a connection to the proper host.

Therefore, a need exists to perform discovery and configuration in an 802.11x wireless network.

### BRIEF SUMMARY OF THE INVENTION

Accordingly, the present invention describes a method to perform discovery and perform configuration in wireless networks which do not provide a specific method to perform these functions.

The invention is described for use in an 802.11x wireless network. There are four physical layer standards from the IEEE in the 802.11x family of standards. These are 802.11, 802.11a, 802.11b, and 802.11g. While these four standards differ markedly, all four use the same MAC layer which is called out in the 802.11 standard and included by reference in the other three.

The MAC layer of 802.11 defines a header which is included in every transmitted packet. The header contains several information elements necessary for the MAC layer of one or more devices in the wireless network to work in harmony. One of these fields is the service set identifier (SSID). The SSID is a field of up to 32 bytes in length that identifies a particular network. An information element consists of three fields, the type field, the length field, and the information field. The type field defines what information is contained in the information field. For the SSID this field is set to 0. The length field gives the length of the information field in bytes. The information field contains the information to be conveyed. In the case of the SSID information element this will contain the ASCII code of the networks SSID. A network is a group of 802.11x capable devices which share a logical connection. According to the 802.11 standard, all devices in the same network use the same value in the SSID field. Several wireless networks may coexist in the same physical area. A wireless device which receives a packet from a second device in the same physical area will check the SSID to determine if the second device is associated with the same network. The physical area in this case is limited to the range of the 802.11x network. This check involves parsing the SSID and determining if the value of the SSID matches the SSID of a network to which the first device is associated. If the SSID of the received packet does not match an SSID of a network to which the first device is associated, the packet will be discarded. In this manner, the SSID allows control of how wireless devices associate with each other. Each network within a given physical region must have a unique SSID.

Embodiments of the present invention take advantage of the flexibility of the SSID field to convey information beyond network identification. Embodiments add data to the SSID field in a predetermined manner. In particular, the data in modified form is appended to the SSID field under the restriction that the total length does not exceed 32 bytes. By appending the data to the present SSID, it is very probable that the resulting SSID will be unique in the small physical areas covered by an 802.11x network. Therefore, this modification is compliant with the 802.11x MAC layer.

Typical information which may be transmitted vary widely depending on the type of devices in use. For example, a Smart Display might request the IP number of the host which is necessary to form a connection. The Smart Display can return such information as the maximum resolution and update rate of the display. According to a method embodiment, a data structure is configured for transmittal to a client device from a host device over a wireless connection. The method includes embedding configuration or discovery information into a portion of an identifier following a protocol limiting the identifier for network identification, like an 802.11x protocol, to enable a client device to be independent of two-way communication with the host device. The method can also include transmitting the identifier to the client device to enable the client device to parse the identifier to retrieve embedded configuration information.

According to another method embodiment for connecting a client device to a host device over a wireless connection, a client device such as a Smart Display receives an identifier and parses the identifier to retrieve embedded configuration information. The identifier follows a protocol limiting the identifier to providing only a network name. IEEE 802.11x is such a protocol. The embedded configuration information assists in establishing communications between the client device and the host device because the embedded configuration information can be used to identify the host. If the identifier is a service set identifier (SSID) described by an IEEE 802.11x protocol, the SSID is a 32 byte ASCII code, and the embedded configuration information can identify a TCP/IP address for connections to one or more slave devices. In one embodiment, the method includes comparing a first M bytes of the received identifier with a stored identifier to determine whether the first M bytes matches a stored identifier in the client device. If a match is found, the method continues by determining that the received identifier contains data, decrypting the data, and locating within the data one or more of a model type, a manufacturer identifier and a device type. The client device can be a handheld computing device, a Smart Display, or a slave device.

Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, can be best understood from the following detailed description taken in conjunction with the accompanying drawings of which:

FIG. 1 is a block diagram generally illustrating an exemplary computer system on which one or more parts of the present invention resides;

FIG. 2 is a block diagram of a network in accordance with embodiments of the present invention.

FIG. 3 is a flow diagram in accordance with an embodiment of the present invention.

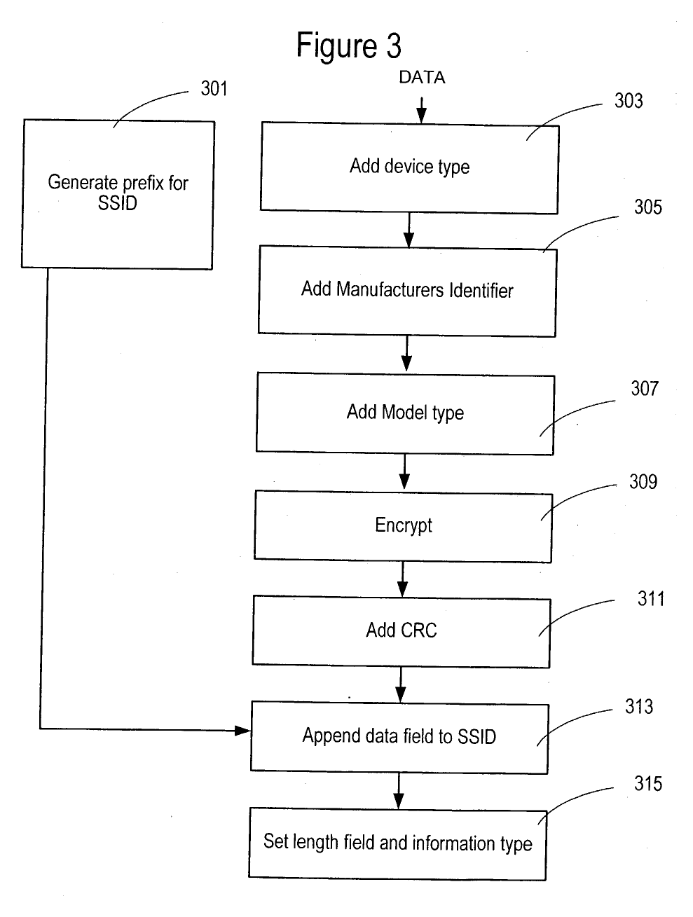

FIG. 4 is a flow diagram in accordance with an embodiment of the present invention.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable- consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

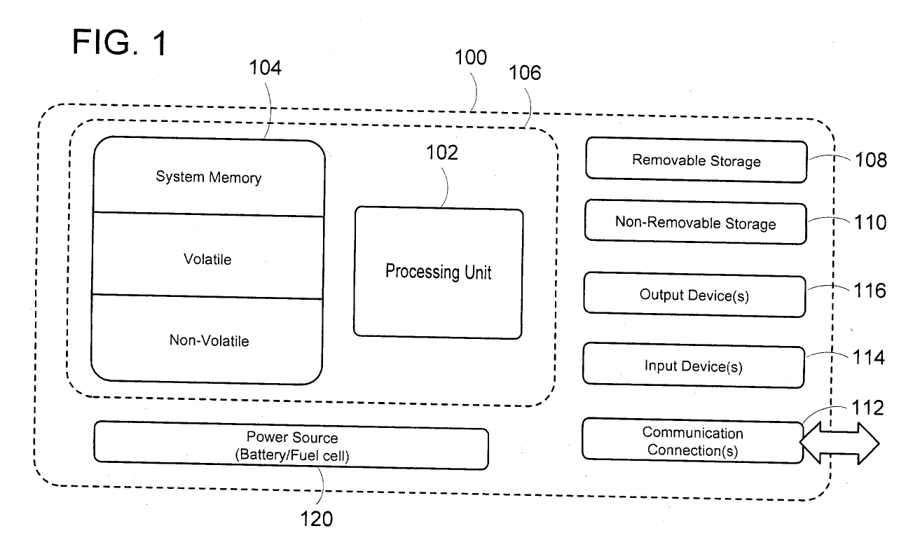

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

This invention operates in a wireless device having a network interface module for accessing a wireless network and a power source, such as a battery pack or the like, that has a limited amount of energy stored therein. Prior to describing the invention in detail, an exemplary computing device in which the invention may be implemented is first described with reference to FIG. 1.

The invention may be implemented in a system employing various types of machines, including cell phones, hand-held devices, wireless surveillance devices, microprocessor-based programmable consumer electronics, and the like, using instructions, such as program modules, that are executed by a processor. Generally, program modules include routines, objects, components, data structures and the like that perform particular tasks or implement particular abstract data types. The term “program” includes one or more program modules.

FIG. 1 shows an exemplary computing device 100 for implementing one or more embodiments of the invention. In its most basic configuration, the computing device 100 includes at least a processing unit 102 and a memory 104. Depending on the exact configuration and type of computing device, the memory 104 may be volatile (such as RAM), non-volatile (such as ROM, flash memory, etc.) or some combination of the two. The basic configuration is illustrated in FIG. 1 by a dashed line 106. Additionally, the device 100 may also have additional features/functionality. For example, the device 100 may also include additional storage (removable and/or non-removable) including, but not limited to, magnetic or optical disks or tapes. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device 100. Any such computer storage media may be part of the device 100.

Device 100 may also contain one or more communications connections 112 which allow the device to communicate with other devices. The communications connections 112 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As discussed above, the term computer readable media as used herein includes both storage media and communication media.

Device 100 may also have one or more input devices 114 such as keyboard, mouse, pen, audio devices, touch-input device, etc. One or more output devices 116 such as a display, speakers, printer, etc. may also be included. All these devices are well known in the art and need not be discussed at greater length here.

The present invention will be described in the general context of a Smart Display connecting to a host computer. Smart Displays have been designed to work over lower bandwidth connections to the host, for example wireless networks thereby allowing the display to be untethered. In order for the Smart Display to connect to the proper host, the Smart Display must be provided with the host name or equivalently the IP number of the host. One method to provide this information is to have the user enter the information. However, having a user enter the information requires that the user have access to information which is not always easy to ascertain or understand. Ideally, a network could supply this information in a method transparent to the user. Embodiments described herein provide a transport mechanism which is one component necessary to implement a protocol to enable discovery and configuration in 802.11x wireless devices.

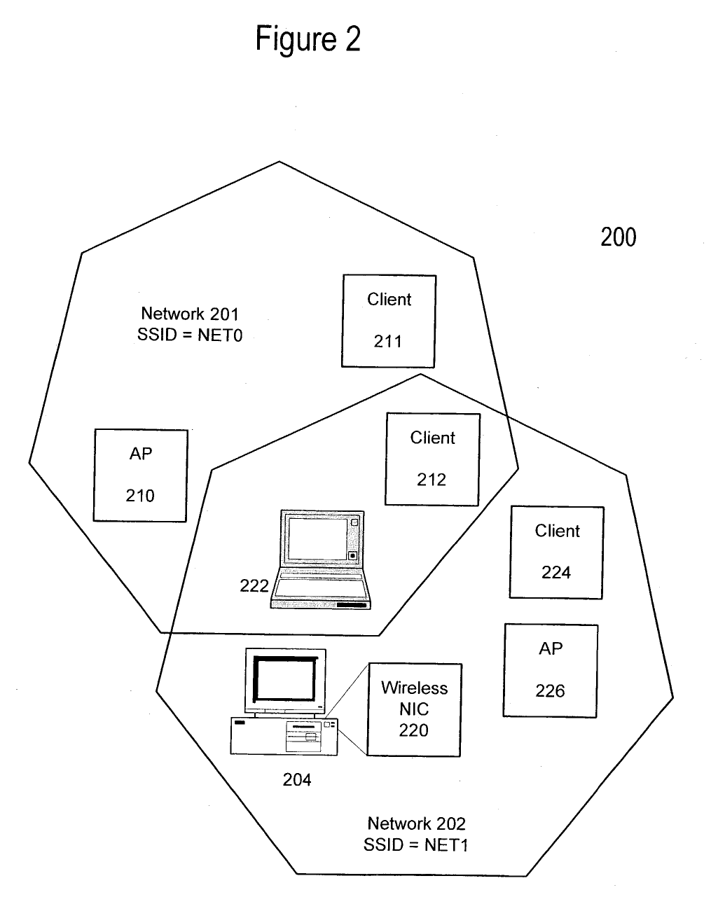

FIG. 2 shows a typical office environment in which several 802.11x networks exist in a small enough physical area that the networks overlap, in accordance with embodiments herein. The physical area contains two networks, 201 and 202. Network 201 is formed by access point (AP) 210 and wireless client devices 211 and 212. Network 202 consists of computer 204 functionally attached to a wireless network interface card (NIC) 220, device 222 which is a Smart Display with wireless client capabilities, and wireless client device 224, and AP 226.

Network 201 is a typical wireless network. In 802.11x networks two types of networks exist, centrally controlled and ad hoc. Centrally controlled networks require that all communications take place through an AP. Ad hoc networks allow communications directly between any two devices in the network.

In a centrally controlled network the AP controls many aspects of network control. All communication by any client device must pass through an AP. In a typical wireless network the AP will be connected to a wide area network (WAN) using Ethernet or other physical communication medium. In many instances the connection of the AP to a wide area network will facilitate internet access. The centrally controlled network with all communications passing through an AP which connected to a WAN is a good configuration when most of the client devices are accessing the WAN.

In a centrally controlled network the AP can set many access parameters such as the SSID, the channel selection, and encryption parameters. This central control makes the protocol to control the network much simpler as there is no chance of a conflict in the assignment the parameters of the network. Further, the AP provides a single point of access for network admittance. The AP will transmit a beacon at regular intervals. A client searching for a wireless network to connect to will search for this beacon for a set amount of time. If no beacon is found the client will try the next channel and so on until a beacon is found. Once a beacon is found the client will contact the AP which produced the beacon and initiate a connection to the wireless in accordance with the procedures outlined in the 802.11x standards.

The other type of network available in 802.11x standards is referred to as ad-hoc. Ad-hoc networks are not centrally controlled. Each wireless device in the network can communicate directly with any other device in the network. Network control and access are distributed among all the devices in the network. This type of network allows groups of wireless devices to form a network and share data without having access to a single controller. Ad-hoc networks are useful for such tasks where data is to be exchanged for example directly between two devices. Examples include exchange of files between two computers or exchange of electronic business cards between PDA's.

The MAC header of an 802.11x packet contains several fields. The exact nature of this header depends on the type of packet being transmitted. However, every 802.11x MAC header and hence every 802.11x packet contains an SSID field. The SSID field is one of several information elements defined in the 802.11 MAC. The information elements, as described above, including the SSID, contain a one byte element identifier (ID), a one byte length field, and a variable length information field. The element ID for the SSID is 0. The length field will give the length of the information field in bytes. The information field contains the data to be sent from the transmitting device to the receiving device. In the case of the SSID, this information field will be a field of 1 to 32 bytes containing a value used to identify a given network. In FIG. 2, network 201 has an SSID of NET0 while network 202 has a SSID of NET1. For both of these SSIDs the length field would be set to 4. The SSID of all overlapping networks must be unique. There is no guarantee that an SSID will be unique, but the size of the SSID and the relatively small number of networks which can overlap in practice make identical SSID assignments unlikely.

To enable discovery and configuration, data can be added to the SSID field. This data can be added in many ways and the following embodiment is meant only to serve as an example of one method. In an embodiment, block 303 of flowchart 300 prepends a one-character device type field to the data. The device type field allows the receiving device to know what type of hardware is associated with the transaction. For example, a Smart Display may be given a device type of 8F in hexadecimal notation. Blocks 305 and 307 similarly add a one byte manufacturer code and a model code respectively. One skilled in the art will appreciate that in specialized scenarios blocks 303, 305, and 307 may be omitted. For example, if the type of device acting as the host can only share information with a given device, then these blocks are unnecessary. Block 309 performs a cryptographic algorithm on the data field. One skilled in the art will also appreciate that many cryptographically secure algorithms exist. The desired algorithm could require the user to enter a trusted code that is displayed on the Smart Display on host to ensure that only a particular device will be discovered and configured by a particular host. If no secret data needs to be protected, then block 309 may be omitted. Block 311 adds a 16bit cyclic redundancy code (CRC) to the data field using the CCITT standard CRC 16 which is also used in the 802.11x standards. In block 313 the sub field generated in block 311 is appended to the SSID. In block 315 the length field and information type fields are generated. The information type is 0 as this is the SSID field. The length field must contain the length of the SSID plus the data passed from block 311. The resulting information element, which includes the information type, length, SSID, and appended information is passed to the physical layer for transmission. The total length of the data emerging from block 313 must be less than 32 bytes. The present description of embodiments herein is limited by this restriction of 32 bytes. However, it is anticipated that there may be a need to pass data of lengths greater than 32 bytes and techniques such as adding packet numbers and continuation bits to the protocol could enable longer data fields to be transmitted over multiple 802.11x packets. Note that any method for establishing longer data lengths would need to take into account that the communications is at first unidirectional. Although this technique does not guarantee that the resulting SSID is unique in a given area, it is highly unlikely that the resulting SSID would match that of another AP in the same physical region. Other techniques for ensuring the SSID is unique will not be discussed in detail, it may be achieved, for example, by simply including a random session component into the SSID broadcast packet.

The host computer 204 and wireless NIC 220 in FIG. 2 can form the host for a system to be used with a Smart Display such as Smart Display 222. Since neither wireless NIC 220 nor Smart Display 222 are configured as an AP, this connection must be ad-hoc. Note that the 802.11x protocol allows operation as both an ad-hoc and centrally controlled network, though not on the same packet. This is a situation in which the host will broadcast information only to a Smart Display. To connect to the host, Smart Display 222 needs to know the IP number of the host computer. In one embodiment of the present invention, host computer 204 and wireless NIC 220 broadcasts the IP address of personal computer 204 at regular intervals, for example once every three seconds, forming the SSID of the packet as described above with the data field containing the IP number of the host computer. When Smart Display 222 is first brought into service, the Smart Display searches for a wireless network for attachment. In FIG. 2 there are two networks available, network 201 and network 202. Suppose that Smart Display 222 first attaches to wireless network 201 that does not contain a host to which Smart Display 222 can attach. Once the connection procedure outlined in the 802.11x standards is completed, the Smart Display acquires the SSID of the network 201, in this case NET0. Smart Display 222 will begin to search for an SSID containing data as described above, searching for the SSID, in this instance NET0. Because network 201 does not contain a host for the Smart Display to connect to, the search will fail. The criteria for failure is to search for an encoded SSID for a period of time long enough to guarantee that N encoded SSIDs have been transmitted. Using a period long enough to guarantee that N encoded SSIDs have been transmitted guards against the possibility that an encoded SSID was missed due to bit errors in the received signal. After attempting to receive an SSID with data and failing on network 201, Smart Display 222 connects to the next available network, network 202. Again, a connection will be established per the 802.11x standard and the SSID found to be NET1. Smart Display 222 will then start to search for the SSID NET1 on packets transmitted by wireless NIC 220 on network 202. Because personal computer 204 and wireless NIC 220 are specially configured to transmit the SSID with data as described, Smart Display 222 detects the SSID. The encoded SSID will be recognized because the characters NET1 will appear at the start of the SSID field however the length field will indicate a longer SSID. Upon detection of the encoded SSID Smart Display 222 removes and decodes the associated data field as described below. In this case, the data field contains the IP number of the host computer to which Smart Display 222 should connect. Once Smart Display 222 knows the IP number of the host to which it can connect, Smart Display 222 acquires an IP number either through DHCP, Auto IP, or alternatively may have a static IP number assigned. Once Smart Display 222 has an IP number it can proceed to connect to the host and function as a display device for personal computer 204.

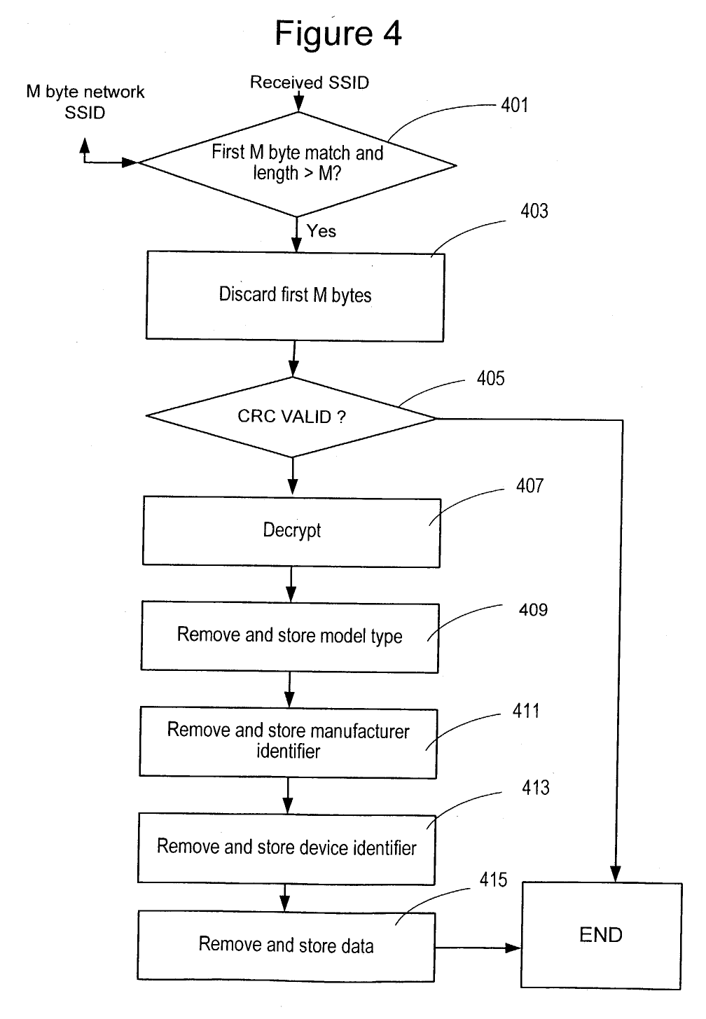

FIG. 4 shows a flow diagram illustrating the detection and parsing of an SSID field with associated data. Block 401 is passed an SSID field and length and compares the first M bytes of the received SSID with a stored copy of a network SSID. More particularly, the stored network SSID has a byte length of M. If every bit of the first M bytes of the received SSID is the same as the stored M byte SSID, then the received SSID field contains data. If these values do not match, then the algorithm ends. In block 403 the first M bytes of the received SSID are discarded. In block 405, the CRC is checked to verify that the data was received without error. If the CRC check indicates that the data was received with bit errors, the algorithm stops. If the CRC indicates that the data was received without error, block 407 decrypts the data using a WEP decryption algorithm. Blocks 409, 411, and 413 remove and store the model type, manufacture ID, and device type respectively. Each of these fields is one byte and therefore easy to parse. Block 415 stores the remainder which is simply the data.

The method outlined above provides that the host simply broadcasts the information required by the Smart Display. The method works well in the case in which the required information and device are known a priori. In another embodiment, devices of unknown type can contact an AP. Assume client device 224 is a PDA which wants to sync to data with a given host computer whenever it is in range. Device 224 can initially contact host computer 204 through access point 220. However, at this point neither device 224 or host computer 204 are aware of the identity of the other as the 802.11x protocol has no means to share this type of information. However, if both devices are equipped to detect the SSID encoded as described above, then discovery of this information is possible. Once the 802.11x connection is established, device 224 can encode an SSID identifying itself as a PDA of a given manufacturer and model type. The data field can be encoded with a unique name such as a name identifying this particular PDA. Upon receipt of this SSID, AP 220 will decode this information and pass it to host computer 204. If host computer recognizes this PDA as one to which the computer should synchronize data, the computer will return an SSID encoded with data to indicate to the PDA that it should prepare to synchronize data and provide an IP number such that synchronization can take place. In addition, host computer 204 launches the software necessary to synchronize with the PDA. The actual synchronization takes place over the standard wireless network through the established IP connection. Note that this synchronization can take place without the need for any user intervention because of the discovery process.

As another example, the host could be contained in a television set and the remote could be a video cassette recorder (VCR). On power on, the VCR would search for and find the AP associated with the television and identify itself as a VCR and provide its manufacturer and model number to the television. The information would, for example, allow the television to look up the remote control codes for that particular VCR. The television can then control the VCR, allowing a single remote control to address all devices associated with video without any user intervention.

In view of the many possible embodiments to which the principles of this invention can be applied, it will be recognized that the embodiment described herein with respect to the drawing figures is meant to be illustrative only and are not be taken as limiting the scope of the invention. For example, those of skill in the art will recognize that the elements of the illustrated embodiment shown in software can be implemented in hardware and vice versa or that the illustrated embodiment can be modified in arrangement and detail without departing from the spirit of the invention. Therefore, the invention as described herein contemplates all such embodiments as can come within the scope of the following claims and equivalents thereof.

We claim:

1. A method of connecting a client device to a host device over a wireless connection, the method comprising:
receiving an identifier over the wireless connection; and
parsing the identifier to retrieve embedded configuration information, the identifier following a protocol limiting the identifier to providing only a network name.

2. The method of claim 1 wherein the embedded configuration information assists in establishing communications between the client device and the host device.

3. The method of claim 1 wherein the embedded configuration information identifies one or more of a name of the host device using the embedded configuration information.

4. The method of claim 1 wherein the identifier is a service set identifier (SSID) described by an IEEE 802.11x protocol.

5. The method of claim 4 wherein the SSID is a 32 bit ASCII code, the embedded configuration information identifying a TCP/IP address for connections to one or more slave devices.

6. The method of claim 1 further comprising:
comparing a first M bytes of the received identifier with a stored identifier to determine whether the first M bytes matches a stored identifier in the client device;
if a match is found, determining that the received identifier contains data;
decrypting the data; and
locating within the data one or more of a model type, a manufacturer identifier and a device type.

7. The method of claim 6 further comprising:
checking a cyclic redundancy code (CRC); and
performing a cryptographic algorithm on the received identifier.

8. The method of claim 1 wherein the client device is one of a handheld computing device, a television, and a slave device.

9. A computer readable medium holding computer readable code for performing acts for connecting a client device to a host device over a wireless connection, the acts comprising:
receiving an identifier over the wireless connection; and
parsing the identifier to retrieve embedded configuration information, the identifier following a protocol limiting the identifier to providing only a network name.

10. The computer readable medium of claim 9 wherein the embedded configuration information assists in establishing communications between the client device and the host device.

11. The computer readable medium of claim 9 wherein the embedded configuration information identifies one or more of a name of the host device using the embedded configuration information.

12. The computer readable medium of claim 9 wherein the identifier is a service set identifier (SSID) described by an IEEE 802.1x protocol.

13. The computer readable medium of claim 12 wherein the SSID is a 32 bit ASCII code, the embedded configuration information identifying a TCP/IP address for connections to one or more slave devices.

14. The computer readable medium of claim 9 wherein the acts include:
comparing a first M bytes of the received identifier with a stored identifier to determine whether the first M bytes matches a stored identifier in the client device;
if a match is found, determining that the received identifier contains data;
decrypting the data; and
locating within the data one or more of a model type, a manufacturer identifier and a device type.

15. The computer readable medium of claim 14 further comprising:
checking a cyclic redundancy code (CRC); and
performing a cryptographic algorithm on the received identifier.

16. The computer readable medium of claim 9 wherein the client device is one of a handheld computing device, a television, a recording device and a slave device.

17. A method of configuring a data structure for transmittal to a client device from a host device over a wireless connection, the method comprising:
locating a portion of an identifier following a protocol limiting the identifier for network identification; and
embedding configuration information into the identifier to enable a client device to be independent of two-way communication with the host device.

18. The method of claim 17 further comprising:
transmitting the identifier to the client device to enable the client device to parse the identifier to retrieve embedded configuration information.

19. The method of claim 17 wherein the embedded configuration information identifies one or more of a name of the host device, a TCP/IP address, a model type, a manufacturer identifier and a device type.

20. The method of claim 17 wherein the identifier is a service set identifier (SSID) described by an IEEE 802.11x protocol.

21. The method of claim 17 wherein the identifier is a 32 bit ASCII code, the embedded configuration information identifying a TCP/IP address for connections to one or more slave devices.

22. The method of claim 17 wherein the embedded configuration information includes cyclic redundancy code (CRC) and cryptographic data.
